(19) United States
(12) Patent Application Publication
(10) Pub. No.: US 2024/0012920 A1
(43) Pub. Date: Jan. 11, 2024

(54) SYSTEM AND METHOD FOR CONTROLLING ACCESS SECURITY PROTOCOLS IN A DATABASE MANAGEMENT SYSTEM

(71) Applicant: BANK OF AMERICA CORPORATION, Charlotte, NC (US)

(72) Inventors: Deepak Gujaba Gaikwad, Singapore (SG); Michael Stuart Gordon, Jacksonville, FL (US); Ragavendiran Sevugan Chetty, Singapore (SG)

(73) Assignee: BANK OF AMERICA CORPORATION, Charlotte, NC (US)

(21) Appl. No.: 17/857,398

(22) Filed: Jul. 5, 2022

(51) Int. Cl. G06F 21/62

(52) U.S. Cl. CPC G06F 21/6218

(57) ABSTRACT

Various systems, methods, and computer program products for controlling access security protocols in a database management system. The method includes monitoring process information relating to a process. The monitoring includes monitoring a security protocol used during an authentication. The method also includes determining the security protocol used during the authentication. The security protocol is a first security protocol (e.g., primary security protocol) or a second security protocol (e.g., backup security protocol). In an instance in which the second security protocol is used, the method includes determining action(s) to allow the authentication to use the first security protocol. The method also includes implementing the action to allow for the authentication to use the first security protocol. The action may include updating the process code to allow for the first security protocol to operate. The method allows for the system to monitor processing to ensure that the primary security protocol is being used.

### TECHNOLOGICAL FIELD

An example embodiment relates generally to authentication and more particularly, to controlling access security protocols in a database management system.

### BACKGROUND

Database management systems use various security protocols in order to protect data within the databases. However, each security protocol has limitations that allow for the databases to be vulnerable to attacks. Therefore, there exists a need for a system that can eliminate such security vulnerabilities.

### BACKGROUND

The following presents a summary of certain embodiments of the disclosure. This summary is not intended to identify key or critical elements of all embodiments nor delineate the scope of any or all embodiments. Its sole purpose is to present certain concepts and elements of one or more embodiments in a summary form as a prelude to the more detailed description that follows.

In an example embodiment, a system for controlling access security protocols in a database management system is provided. The system includes at least one non-transitory storage device and at least one processing device coupled to the at least one non-transitory storage device. The at least one processing device is configured to monitor process information relating to a process. Monitoring the processing information relating to a process includes monitoring a security protocol used during an authentication of the process. The at least one processing device is also configured to determine the security protocol used during the authentication. The security protocol is a first security protocol or a second security protocol. The at least one processing device is further configured to, in an instance in which the second security protocol is used in the authentication, determine one or more actions to allow the authentication to use the first security protocol. The at least one processing device is still further configured to implement the action to allow for the authentication to use the first security protocol.

In some embodiments, the first security protocol uses an identity information to perform the authentication and the second security protocol is used in an instance in which the identity information is not provided. In some embodiments, at least one of the one or more actions includes updating a process code to allow for the first security protocol to operate.

In some embodiments, at least one of the actions includes creating a user identity information based on the process, and the user identity information is used in place of the identity information. In some embodiments, the user identity information includes access level to one or more process relating to a user.

In some embodiments, the at least one processing device is configured to actively monitor the security protocol used for the authentication. In some embodiments, the at least one processing device is configured to cause a transmission of a notification in an instance in which the second security protocol is used in the authentication.

In another example embodiment, a computer program product for controlling access security protocols in a database management system is provided. The computer program product includes at least one non-transitory computer-readable medium having computer-readable program code portions embodied therein. The computer-readable program code portions include an executable portion configured to monitor process information relating to a process. Monitoring processing information relating to a process includes monitoring a security protocol used during an authentication of the process. The computer-readable program code portions also include an executable portion configured to determine the security protocol used during the authentication. The security protocol is a first security protocol or a second security protocol. The computer-readable program code portions further include an executable portion configured to, in an instance in which the second security protocol is used in the authentication, determine one or more actions to allow the authentication to use the first security protocol. The computer-readable program code portions still further include an executable portion configured to implement the action to allow for the authentication to use the first security protocol.

In some embodiments, the first security protocol uses an identity information to perform the authentication, and the second security protocol is used in an instance in which the identity information is not provided. In some embodiments, at least one of the one or more actions includes updating a process code to allow for the first security protocol to operate.

In some embodiments, at least one of the actions includes creating a user identity information based on the process and the user identity information is used in place of the identity information. In some embodiments, the user identity information includes access level to one or more process relating to a user.

In some embodiments, the computer program product further includes an executable portion configured to actively monitor the security protocol used for the authentication. In some embodiments, the computer program product further includes an executable portion configured to cause a transmission of a notification in an instance in which the second security protocol is used in the authentication.

In still another example embodiment, a computer-implemented method for controlling access security protocols in a database management system. The method includes monitoring process information relating to a process. Monitoring processing information relating to a process includes monitoring a security protocol used during an authentication of the process. The method also includes determining the security protocol used during the authentication. The security protocol is a first security protocol or a second security protocol. The method further includes, in an instance in which the second security protocol is used in the authentication, determining one or more actions to allow the authentication to use the first security protocol. The method still further includes implementing the action to allow for the authentication to use the first security protocol.

In some embodiments, the first security protocol uses an identity information to perform the authentication and the second security protocol is used in an instance in which the identity information is not provided. In some embodiments, at least one of the one or more actions includes updating a process code to allow for the first security protocol to operate.

In some embodiments, at least one of the actions includes creating a user identity information based on the process and the user identity information is used in place of the identity information. In such an embodiment, the user identity information includes access level to one or more process relating to a user.

In some embodiments, the method also includes actively monitoring the security protocol used for the authentication. In some embodiments, the method also includes causing a transmission of a notification in an instance in which the second security protocol is used in the authentication.

Embodiments of the present disclosure address the above needs and/or achieve other advantages by providing apparatuses (e.g., a system, computer program product and/or other devices) and methods for controlling access security protocols in a database management system. The system embodiments may comprise one or more memory devices having computer readable program code stored thereon, a communication device, and one or more processing devices operatively coupled to the one or more memory devices, wherein the one or more processing devices are configured to execute the computer readable program code to carry out said embodiments. In computer program product embodiments of the disclosure, the computer program product comprises at least one non-transitory computer readable medium comprising computer readable instructions for carrying out said embodiments. Computer implemented method embodiments of the disclosure may comprise providing a computing system comprising a computer processing device and a non-transitory computer readable medium, where the computer readable medium comprises configured computer program instruction code, such that when said instruction code is operated by said computer processing device, said computer processing device performs certain operations to carry out said embodiments.

### BRIEF DESCRIPTION OF THE DRAWINGS

Having thus described embodiments of the invention in general terms, reference will now be made the accompanying drawings, wherein:

FIGS. 1A-1C illustrates technical components of an exemplary distributed computing environment for controlling access security protocols in a database management system, in accordance with an embodiment of the disclosure; and

FIG. 2 provides a flowchart illustrating a method of controlling access security protocols in a database management system in accordance with an embodiment of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

Systems use various security protocols to authenticate the identity of a user. An example of the security protocols uses an accessor environment element (ACEE), which is a control block that represents the identity of the user. The ACEE may be used in connection with a database that contains access-control information to determine an access level for a user. However, in an instance a user is unauthenticated (e.g., an ACEE is not present because a user does not log into the system), a second security protocol may be used for authentication. However, it may be more secure for the authentication to use the first security protocol. To do this, in an instance in which a user is unauthenticated, the system defines an account with the user identification value of the unauthorized user and the processing action. The system is then configured to allow the process to be authenticated via the first security protocol (e.g., a preferred security protocol, such as resource access control facility (RACF)).

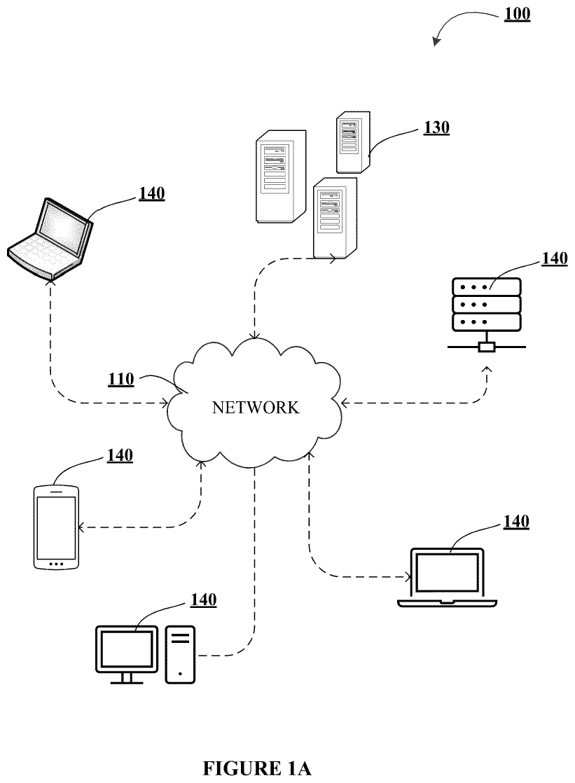

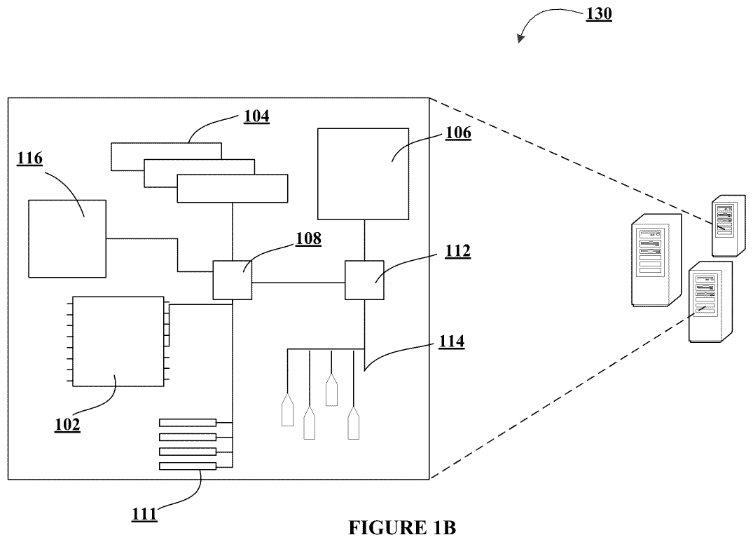

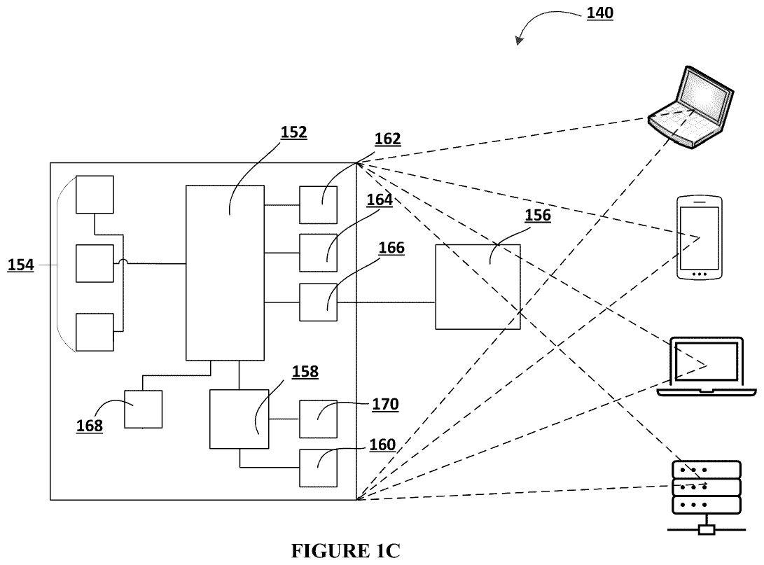

FIGS. 1A-1C illustrate technical components of an exemplary distributed computing environment for controlling access security protocols in a database management system 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

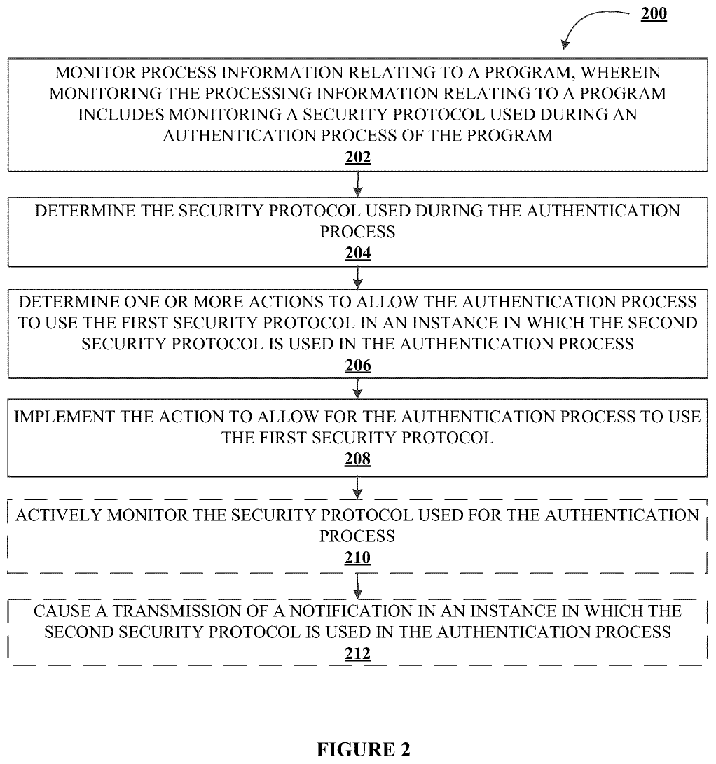

FIG. 2 is a flow chart 200 that illustrates another example method of controlling access security protocols in a database management system. The method may be carried out by various components of the distributed computing environment 100 discussed herein (e.g., the system 130, one or more end-point devices 140, etc). An example system may include at least one non-transitory storage device and at least one processing device coupled to the at least one non-transitory storage device. In such an embodiment, the at least one processing device is configured to carry out the method discussed herein.

Referring now to Block 202 of FIG. 2, the method includes monitoring process information relating to a process. Monitoring the processing information relating to a process includes monitoring a security protocol used during an authentication of the process. The process may be executed based on a request by a user, such as an initiation of a processing, such as a transaction. The process may be any interaction with a database, such as a requested process and/or the like. The system may have an authentication that uses a primary security protocol (e.g., a first security protocol). The first security protocol may be a security protocol that verifies and authenticates a user (e.g., the first security protocol may be a RACF protocols).

The first security protocol may be used unless one or more necessary components are not present. For example, in an instance in which the first security protocol is RACF, the first security protocol may be used unless there is no user identity provided (e.g., no ACEE provided) for the process. In such an instance, a backup security protocol (e.g., a second security protocol) may be used to authenticate the process. The first security protocol may be preferred and therefore, the system is more secure in an instance in which the first security protocol is used.

Referring now to Block 204 of FIG. 2, the method includes determining the security protocol used during the authentication. Since the system may be more secure in an instance a first security protocol is being used instead of a second security protocol, it is helpful to determine which security protocol is being used for a given process. In various embodiments, the system is configured to monitor the security protocol used for a process. The monitoring of the security protocol may be continuous or periodic. As such, the monitoring of the security protocol may be real-time or near real-time. In an instance in which the first security protocol is used for the authentication of the process, the system may operate without any changes to the process.

Referring now to Block 206 of FIG. 2, the method includes determining one or more actions to allow the authentication to use the first security protocol in an instance in which the second security protocol is used in the authentication. At least one of the one or more actions includes updating a process code to allow for the first security protocol to operate.

The process code may be updated to include a user identity information based on the process and a user that requests the process. The user identity information may mimic a ACEE or other user identity that allows for the first security protocol (e.g., RACF) to authenticate the process. In various embodiments, one of the actions includes creating a user identity information based on the process. The user identity information may be created based on information provided with the process request (e.g., including information relating to a user). The user identity information may include access level to one or more process relating to a user. The one or more actions may include various other actions that allow for the first security protocol to be used for the authentication of the process. The user identity information may include a user identification value and the process (or program) involved in a transaction.

Referring now to Block 208 of FIG. 2, the method includes implementing the action to allow for the authentication to use the first security protocol. In various embodiments, the changes to the process code may be implemented automatically (e.g., the code may be automatically used with the user identity information). In an example embodiment, in an instance in which the first security protocol is RACF and the second security protocol is used, the standard db2 exit routine is modified to identify the user identity information and in such an instance in which the user identity information is provided, RACF is used to authenticate the process.

Referring now to optional Block 210 of FIG. 2, the method includes actively monitoring the security protocol used for the authentication. The system may be configured to monitor the security protocol used for a process in real-time or near real-time. Therefore, the system can determine an instance in which a non-preferred security protocol is used (e.g., the second security protocol).

Referring now to optional Block 212 of FIG. 2, the method includes causing a transmission of a notification in an instance in which the second security protocol is used in the authentication. The notification may be transmitted in an instance in which the system is actively monitoring the security protocol used for the authentication. The notification may be transmitted in place of the changes discussed herein (e.g., to allow for manual intervention). Additionally or alternatively, the notification may be transmitted in conjunction with the actions discussed above (e.g., changing the process code) in order for the changes to be verified and/or monitored. The notification may be provided to an end point device 140.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for controlling access security protocols in a database management system, the system comprising:
at least one non-transitory storage device; and
at least one processing device coupled to the at least one non-transitory storage device, wherein the at least one processing device is configured to:
monitor process information relating to a process, wherein monitoring the processing information relating to a process comprises monitoring a security protocol used during an authentication of the process;
determine the security protocol used during the authentication, wherein the security protocol is a first security protocol or a second security protocol;
in an instance in which the second security protocol is used in the authentication, determine one or more actions to allow the authentication to use the first security protocol; and
implement the action to allow for the authentication to use the first security protocol.

2. The system of claim 1, wherein the first security protocol uses an identity information to perform the authentication, wherein the second security protocol is used in an instance in which the identity information is not provided.

3. The system of claim 1, wherein at least one of the one or more actions comprises updating a process code to allow for the first security protocol to operate.

4. The system of claim 2, wherein at least one of the actions comprises creating a user identity information based on the process, wherein the user identity information is used in place of the identity information.

5. The system of claim 4, wherein the user identity information comprises access level to one or more process relating to a user.

6. The system of claim 1, wherein the at least one processing device is configured to actively monitor the security protocol used for the authentication.

7. The system of claim 1, wherein the at least one processing device is configured to cause a transmission of a notification in an instance in which the second security protocol is used in the authentication.

8. A computer program product for controlling access security protocols in a database management system, the computer program product comprising at least one non-transitory computer-readable medium having computer-readable program code portions embodied therein, the computer-readable program code portions comprising:
an executable portion configured to monitor process information relating to a process, wherein monitoring processing information relating to a process comprises monitoring a security protocol used during an authentication of the process;
an executable portion configured to determine the security protocol used during the authentication, wherein the security protocol is a first security protocol or a second security protocol;
an executable portion configured to, in an instance in which the second security protocol is used in the authentication, determine one or more actions to allow the authentication to use the first security protocol; and
an executable portion configured to implement the action to allow for the authentication to use the first security protocol.

9. The computer program product of claim 8, wherein the first security protocol uses an identity information to perform the authentication, wherein the second security protocol is used in an instance in which the identity information is not provided.

10. The computer program product of claim 8, wherein at least one of the one or more actions comprises updating a process code to allow for the first security protocol to operate.

11. The computer program product of claim 9, wherein at least one of the actions comprises creating a user identity information based on the process, wherein the user identity information is used in place of the identity information.

12. The computer program product of claim 11, wherein the user identity information comprises access level to one or more process relating to a user.

13. The computer program product of claim 8, wherein the computer program product further comprises an executable portion configured to actively monitor the security protocol used for the authentication.

14. The computer program product of claim 8, wherein the computer program product further comprises an executable portion configured to cause a transmission of a notification in an instance in which the second security protocol is used in the authentication.

15. A computer-implemented method for controlling access security protocols in a database management system, the method comprising:
monitoring process information relating to a process, wherein monitoring processing information relating to a process comprises monitoring a security protocol used during an authentication of the process;
determining the security protocol used during the authentication, wherein the security protocol is a first security protocol or a second security protocol;
in an instance in which the second security protocol is used in the authentication, determining one or more actions to allow the authentication to use the first security protocol; and
implementing the action to allow for the authentication to use the first security protocol.

16. The method of claim 15, wherein the first security protocol uses an identity information to perform the authentication, wherein the second security protocol is used in an instance in which the identity information is not provided.

17. The method of claim 15, wherein at least one of the one or more actions comprises updating a process code to allow for the first security protocol to operate.

18. The method of claim 16, wherein at least one of the actions comprises creating a user identity information based on the process, wherein the user identity information is used in place of the identity information, wherein the user identity information comprises access level to one or more process relating to a user.

19. The method of claim 15, further comprising actively monitoring the security protocol used for the authentication.

20. The method of claim 15, further comprising causing a transmission of a notification in an instance in which the second security protocol is used in the authentication.
